(19) United States
(12) Patent Application Publication
(10) Pub. No.: US 2010/0106665 A1
(43) Pub. Date: Apr. 29, 2010

(54) INFECTIOUS DISEASE HEALTHCARE DELIVERY SYSTEMS AND METHODS

(76) Inventor: Leo Einck, McLean, VA (US)

Correspondence Address: KING & SPALDING, 1180 PEACHTREE STREET , NE, ATLANTA, GA, 30309-3521, US

(21) Appl. No.: 11/991,684

(22) PCT Filed: Sep. 8, 2006
(86) PCT No.: PCT/US2006/035118

§ 371 Date: Jan. 6, 2010

Related U.S. Application Data
(60) Provisional application No. 60/715,300, filed on Sep. 8, 2005.

(51) Int. Cl. G06Q 90/00

(52) U.S. Cl. 705/500

(57) ABSTRACT

The invention relates to infectious disease healthcare systems and methods. One embodiment of systems and processes according to various embodiments of the invention focuses on a method for providing a healthcare delivery franchise system. The method includes creating a not-for-profit franchisor entity. In addition, the method includes assessing a plurality of locations for a corresponding plurality of healthcare delivery clinics, wherein the demand for healthcare services from each healthcare delivery clinic and the revenue from each healthcare delivery clinic are estimated. Furthermore, the method includes based at least in part on the demand and revenue estimates, constructing at least a portion of the plurality of healthcare delivery clinics in corresponding locations, wherein the portion of the plurality of healthcare delivery clinics is associated with the not-for-profit franchisor entity.

### TECHNICAL FIELD

The invention is generally directed to healthcare. More particularly, the invention relates to infectious disease healthcare systems and methods.

### BACKGROUND

Infectious diseases can cause significant morbidity and mortality across the globe and are responsible for approximately 18 million deaths and a loss of over 600 million Disability Adjusted Life Years (DALYs) worldwide every year (Ridley, 2005). Most of these diseases are preventable (through use of vaccines) or treatable (through proper application of drugs and palliative treatments), yet they continue to affect millions of people each year. One impediment to the control of these diseases is not the lack of effective treatments, since many diseases do have effective vaccines and drugs, but the inability to deliver appropriate healthcare in a timely and efficient manner. In many instances, new and more effective treatments are often difficult to distribute timely and efficiently once they become available.

Individuals and governments alike are moved by media stories and images emanating from poverty-laden and disease-stricken populations. The donations of these generous individuals and governments often times provide healthcare where otherwise there may be none. Unfortunately, the problem of poverty and disease is already large and getting larger, outpacing even the most generous of patrons. While campaigns to focus donations on poverty-facilitated diseases, like HIV (human immunodeficiency virus), TB (tuberculosis), and malaria, are critical in the short term, a sustainable, local, and long term solution is needed. While short term solutions and initiatives can mitigate human suffering, the systemic problems of healthcare delivery are often left unaddressed.

While many existing diagnostics, vaccines, and therapies are available to prevent or treat any number of infectious diseases, conventional healthcare delivery systems and methods are strikingly inefficient at moving these products and services to places where they may be needed, even in relatively wealthy, developed countries. While monies from many sources are generously poured into various conventional healthcare delivery systems and methods, such monies are inefficiently utilized, accountability may be poor, and many of the basic problems of healthcare access over time have yet to be addressed. In many instances, the public healthcare system ignores many of the market forces that can drive efficiency. As a result, large bureaucracies have developed within the public healthcare system, thus adding to the inefficiency and inadequacy of the system. Currently, there is no suitable plan for resolving the financial discrepancy between global healthcare needs and the limited generosity of wealthy nations and donors.

Attempts to resolve financial discrepancies and deliver more efficient healthcare exist in at least two conventional healthcare delivery systems. One focuses on distributing essential medications in remote communities, and the other focuses on distributing family planning and reproductive healthcare. In the first conventional system, two types of facilities dispense healthcare services and products: (1) basic, over-the-counter drug shops operated by community health workers; and (2) clinics operated by nurses who can provide a longer list of essential medicines as well as basic primary care. Each of the basic, over-the-counter drug shops and clinics is a franchisee, and is operated by a community of health workers. The workers at the basic, over-the-counter drug shops can make a modest living selling competitively-priced over-the-counter drugs at the basic, over-the-counter drug shops. The nurses at the clinics can also provide over-the-counter drugs and services targeting some of the most common killer diseases, including malaria, respiratory infections, and dysentery. In addition, the clinics can also provide health education and prevention services.

The other conventional system includes a franchise network of rural centers and medical clinics. The rural centers can sell subsidized products such as over-the-counter drugs and medical supplies. Rural practitioners and private doctors at rural centers deliver drugs and supplies through over 30,000 shops. Doctors provide clinical services through the medical clinics, and rural providers create access to products and services for village communities. A parent organization of the network exists, but decisionmaking for the network is decentralized. The country programs are given complete operational autonomy. While this particular conventional system maintains a small core management team with a high level of communication, the system outsources field work in a competitive framework, so that the gain of one is always at the loss of another.

Neither of the two conventional healthcare delivery systems described above are effective infectious disease healthcare delivery systems.

Therefore a need exists for infectious disease healthcare delivery systems and methods.

### SUMMARY OF THE INVENTION

Accordingly, systems and methods according to various aspects and embodiments according to the invention address at least some or all of these issues and combinations of them. They do so at least in part by providing infectious disease healthcare systems and methods.

Embodiments of the invention can provide a not-for-profit global healthcare enterprise with a distribution and sales franchise organization of commercial business units (clinics) and regional units that can be either for-profit or not-for-profit entities. The franchisor (foundation), as a not-for-profit, can act in the public interest and can provide the associated franchise clinics and regional units with the products, processes, and support they may need to provide healthcare. Each of the associated clinics and regional units can include at least one source of start-up capital (owner-physician and/or a benefactor), a local physician/pharmacist/operator, a physical location (territory), and a set of contractual obligations with the franchise (foundation). Monies, such as franchise fees and operating surpluses, can be transmitted to the franchisor (foundation) by clinics and/or regional units, and can be used to expand and improve healthcare delivery in some or all of the clinics and regional units. In addition, the franchisor (foundation) can receive donations from other entities, foundations, corporations, NGOs, and individuals. Each clinic and regional unit can be motivated to succeed by providing better services and each will benefit from a relatively simple infrastructure, a large measure of autonomy, increased salaries or financial incentives, and improved working conditions.

Embodiments of the invention can provide infectious disease healthcare systems and methods including a healthcare franchise with one or more stand alone clinics operating under an agreement with a franchisor. Each of the clinics can offer relatively effective diagnostic, preventative, and therapeutic care for one or more infectious diseases. Such clinics can supplement and cooperate with existing public and private healthcare agencies and organizations. Each clinic can serve as an initial point of healthcare access, and as a specialist for one or more infectious diseases. As a specialist clinic, the clinics can serve as both an educator, teaching the local population about infectious diseases, and as a monitor, tracking symptoms of infectious diseases in the patients visiting the clinic. In most instances, the clinics can be integrated within some or all existing and conventional healthcare agencies and organizations. In this manner, effective infectious disease healthcare delivery can be facilitated by a supportive franchise system spread across the economic healthcare spectrum to create an impact on consumers (patients) and to provide sustainability by challenging and involving the private sector.

Embodiments of the invention can benefit consumers (patients), doctors and other healthcare professionals as well as countries that may offer deficient or sub-standard healthcare for their citizens. Consumers such as patients can receive the advantages of readily available, state of the art healthcare and other medical services. In particular, embodiments of the invention can increase the availability of standardized healthcare to populations of isolated or poor consumers or patients. The use of embodiments of the invention by doctors, healthcare professionals, organizations, and state and national governments can increase the quality of public health and the standard of living for each entity involved.

Embodiments of the invention can also provide replicable systems and processes that can implemented relatively quickly. In particular, each healthcare delivery clinic can include a base unit that is a self-contained, stand alone facility to provide a suitable location for one or more professionals to dispense healthcare and medical services. Each base unit can include a standardized floor plan with one or more functional areas to provide healthcare services to patients. The base unit can also include network communications equipment to facilitate communications with other clinics or a centralized home facility or franchisor entity, such as a not-for-profit franchisor or foundation-type entity.

As defined and used within this specification, a “franchise” refers to an organization with one or more franchisee-type organizations.

As defined and used within this specification, a “franchisor” refers to an organization with management responsibilities over one or more franchisee-type organizations.

As defined and used within this specification, a “clinic” refers to a physical facility capable of housing one or more healthcare personnel providing healthcare services.

As defined and used within this specification, a “healthcare need” refers to any healthcare service including, but not limited to, family care, birth control, and treatment of an infectious disease.

One embodiment of systems and processes according to various embodiments of the invention focuses on a method for providing a healthcare delivery franchise system. The method includes creating a not-for-profit franchisor entity. In addition, the method includes assessing a plurality of locations for a corresponding plurality of healthcare delivery clinics, wherein the demand for healthcare services from each healthcare delivery clinic and the revenue from each healthcare delivery clinic are estimated. Furthermore, the method includes based at least in part on the demand and revenue estimates, constructing at least a portion of the plurality of healthcare delivery clinics in corresponding locations, wherein the portion of the plurality of healthcare delivery clinics is associated with the not-for-profit franchisor entity.

One aspect of an embodiment of the invention includes assessing a demand for treatment of at least one infectious disease in each location, wherein constructing at least a portion of the plurality of healthcare delivery clinics is further based on the demand for treatment of the at least one infectious disease in each location.

Another aspect of an embodiment of the invention provides that each healthcare delivery clinic is capable of providing healthcare to patients with the at least one infectious disease.

Another aspect of an embodiment of the invention provides that the not-for-profit franchisor entity is a foundation-type organization.

Another aspect of an embodiment of the invention provides that each healthcare delivery clinic is a stand alone facility in communication with the not-for-profit franchisor entity.

Another aspect of an embodiment of the invention provides that the not-for-profit franchisor entity is capable of providing each healthcare delivery clinic with at least one of the following: a medical product, a drug, a vaccine, instructions for performing a medical procedure, operational instructions, or medical supplies.

Another aspect of an embodiment of the invention provides that at least one healthcare delivery clinic provides the not-for-profit franchisor with at least one of the following: a franchise fee, surplus operating funds, or a report associated with the quantity of healthcare services provided to patients

Yet another embodiment of systems and processes according to various embodiments of the invention focuses on a method for providing a healthcare delivery franchise system. The method includes evaluating at least one location for a healthcare delivery clinic. Furthermore, the method includes estimating a demand for healthcare services in the at least one location. In addition, the method includes estimating a revenue from healthcare services in the at least one location. Moreover, the method includes based at least in part on the estimated demand and estimated revenue, constructing a test healthcare delivery clinic in the one location and generating operational procedures for the test healthcare delivery clinic. Further, the method includes refining the test healthcare delivery clinic based at least in part on operating the test healthcare delivery clinic in the one location. The method also includes based at least in part on refining and operating the test healthcare delivery clinic, constructing a plurality of healthcare delivery clinics in a corresponding plurality of locations, wherein each of the healthcare delivery clinics is associated with a not-for-profit franchisor entity.

One aspect of an embodiment of the invention provides that the demand is based in part on at least one of the following: a market analysis of potential patients, or an epidemiological analysis of at least one infectious disease in the one location.

Another aspect of an embodiment of the invention provides that each healthcare delivery clinic is capable of providing healthcare to patients with at least one infectious disease.

Another aspect of an embodiment of the invention provides that the not-for-profit franchisor entity is a foundation-type organization.

Another aspect of an embodiment of the invention provides that each healthcare delivery clinic is a stand alone facility in communication with the not-for-profit franchisor entity.

Another aspect of an embodiment of the invention provides that the not-for-profit franchisor entity is capable of providing each healthcare delivery clinic with at least one of the following: a medical product, a drug, a vaccine, instructions for performing a medical procedure, operational instructions, or medical supplies.

Another aspect of an embodiment of the invention provides that at least one healthcare delivery clinic provides the not-for-profit franchisor with at least one of the following: a franchise fee, surplus operating funds, or a report associated with the quantity of healthcare services provided to patients.

Yet another embodiment of systems and processes according to various embodiments of the invention focuses on a healthcare delivery clinic with a physical location. The healthcare delivery clinic includes an association with a not-for-profit franchisor entity. Furthermore, the healthcare delivery clinic includes a standardized floor plan with at least one functional area, wherein the floor plan is common to at least one other healthcare delivery clinic associated with the not-for-profit franchisor entity. Furthermore, the healthcare delivery clinic includes a communication link for sharing information with the not-for-profit franchisor entity.

One aspect of an embodiment of the invention provides that the physical location of the clinic is determined at least in part on an assessment of a demand for treatment of at least one infectious disease in a vicinity of the physical location, and further determined at least in part on an assessment of demand for treatment of the one infectious disease in the vicinity of the physical location.

Another aspect of an embodiment of the invention provides that the healthcare delivery clinic is capable of providing healthcare to patients with at least one infectious disease.

Another aspect of an embodiment of the invention provides that the not-for-profit franchisor entity is a foundation-type organization.

Another aspect of an embodiment of the invention provides that the healthcare delivery clinic is a stand alone facility in communication with the not-for-profit franchisor entity.

Another aspect of an embodiment of the invention provides that the not-for-profit franchisor entity is capable of providing the healthcare delivery clinic with at least one of the following: a medical product, a drug, a vaccine, instructions for performing a medical procedure, operational instructions, or medical supplies.

Another aspect of an embodiment of the invention provides that the healthcare delivery clinic provides the not-for-profit franchisor with at least one of the following: a franchise fee, surplus operating funds, or a report associated with the quantity of healthcare services provided to patients.

One embodiment of systems and processes according to various embodiments of the invention focuses on a method for providing a healthcare delivery franchise system. The method includes creating a for-profit franchisor entity. In addition, the method includes assessing a plurality of locations for a corresponding plurality of healthcare delivery clinics, wherein the demand for healthcare services from each healthcare delivery clinic and the revenue from each healthcare delivery clinic are estimated. Furthermore, the method includes based at least in part on the demand and revenue estimates, constructing at least a portion of the plurality of healthcare delivery clinics in corresponding locations, wherein the portion of the plurality of healthcare delivery clinics is associated with the franchisor entity.

One aspect of an embodiment of the invention includes assessing a demand for treatment of at least one healthcare need in each location, wherein constructing at least a portion of the plurality of healthcare delivery clinics is further based on the demand for treatment of the at least one healthcare need in each location.

One aspect of an embodiment of the invention provides that the franchisor entity is at least one of the following: a for-profit entity, or a not-for-profit entity.

Yet another embodiment of systems and processes according to various embodiments of the invention focuses on a method for providing a healthcare delivery franchise system. The method includes evaluating at least one location for a healthcare delivery clinic. Furthermore, the method includes estimating a demand for healthcare services in the at least one location. In addition, the method includes estimating a revenue from healthcare services in the at least one location. Moreover, the method includes based at least in part on the estimated demand and estimated revenue, constructing a test healthcare delivery clinic in the one location and generating operational procedures for the test healthcare delivery clinic. Further, the method includes refining the test healthcare delivery clinic based at least in part on operating the test healthcare delivery clinic in the one location. The method also includes based at least in part on refining and operating the test healthcare delivery clinic, constructing a plurality of healthcare delivery clinics in a corresponding plurality of locations, wherein each of the healthcare delivery clinics is associated with a franchisor entity.

One aspect of an embodiment of the invention provides that the demand is based in part on at least one of the following: a market analysis of potential patients, or an analysis of at least one healthcare need in the one location.

One aspect of an embodiment of the invention provides that the franchisor entity is at least one of the following: a for-profit entity, or a not-for-profit entity.

Yet another embodiment of systems and processes according to various embodiments of the invention focuses on a healthcare delivery clinic with a physical location. The healthcare delivery clinic includes an association with a franchisor entity. Furthermore, the healthcare delivery clinic includes a standardized floor plan with at least one functional area, wherein the floor plan is common to at least one other healthcare delivery clinic associated with the franchisor entity. Furthermore, the healthcare delivery clinic includes a communication link for sharing information with the franchisor entity.

One aspect of an embodiment of the invention provides that the physical location of the clinic is determined at least in part on an assessment of a demand for treatment of at least one healthcare need in a vicinity of the physical location, and further determined at least in part on an assessment of demand for treatment of the one healthcare need in the vicinity of the physical location.

One aspect of an embodiment of the invention provides that the franchisor entity is at least one of the following: a for-profit entity, or a not-for-profit entity.

Another aspect of an embodiment of the invention provides that the healthcare delivery clinic is capable of providing healthcare to patients with at least one healthcare need.

These example embodiments are mentioned not to limit or define the invention, but to provide examples of embodiments of the invention to aid understanding thereof. Example embodiments are discussed in the Detailed Description, and further description of the invention is provided there.

Objects, features and advantages of various systems and processes according to various embodiments of the invention can include:

(1) Providing infectious disease healthcare delivery systems and methods;

(2) Providing a franchise system for delivering infectious disease healthcare;

(3) Providing a clinic for delivering infectious disease healthcare;

(4) Providing systems and methods for delivering infectious disease healthcare;

(5) Providing healthcare delivery franchise systems and methods; and

(6) Providing healthcare delivery clinics and methods.

Other objects, features and advantages will become apparent with respect to the remainder of this document.

### BRIEF DESCRIPTION OF THE DRAWINGS

These and other features, aspects, and advantages of the invention are better understood when the following Detailed Description is read with reference to the accompanying drawings, wherein:

FIG. 1 illustrates an example of a process flow associated with providing an infectious disease healthcare delivery system in accordance with an embodiment of the invention.

FIG. 2 illustrates an example of a franchise system in accordance with an embodiment of the invention.

FIG. 3 illustrates an example of a process flow associated with a franchise system in accordance with an embodiment of the invention.

FIG. 4 illustrates an example clinic for a franchise system in accordance with an embodiment of the invention.

FIG. 5 illustrates an example network for a franchise system in accordance with an embodiment of the invention.

FIG. 6 illustrates an example process flow associated with providing an infectious disease healthcare delivery system in accordance with an embodiment of the invention.

### DETAILED DESCRIPTION OF EMBODIMENTS

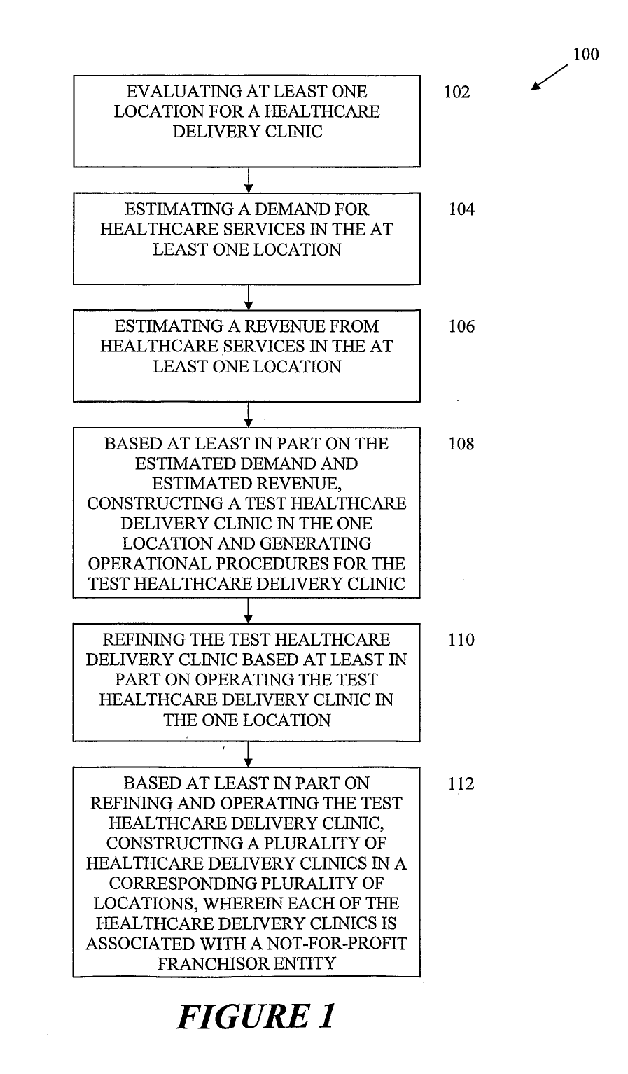

Referring now to the drawings in which like numerals indicate like elements throughout the several figures, FIG. 1 illustrates a process for providing an infectious disease healthcare delivery system in accordance with an embodiment of the invention. In particular, the process 100 shown illustrates particular elements for designing, developing, and refining an infectious disease healthcare delivery system in accordance with an embodiment of the invention. In other embodiments of the invention, the process of FIG. 1 may not be limited to delivery of healthcare for infectious diseases, but may also relate to delivery of healthcare for one or more healthcare needs including, but not limited to, family care, birth control, and treatment of a particular infectious disease. One skilled in the art will recognize the applicability of processes and associated systems disclosed herein to the delivery of healthcare and related healthcare services to any healthcare need, including those disclosed above.

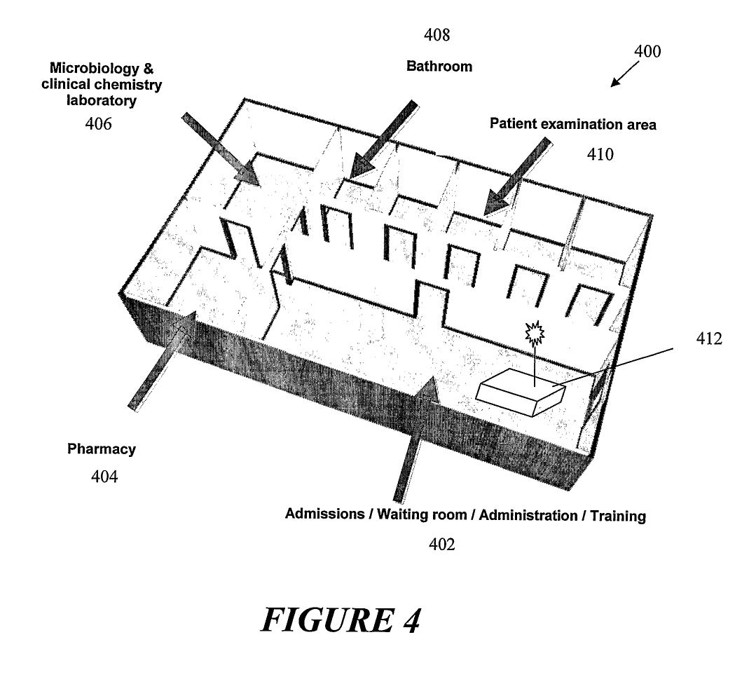

In the embodiment shown in FIG. 1, the process 100 begins at block 102, in which at least one location for a healthcare delivery clinic is evaluated. In this embodiment, block 102 begins the “design stage”, in which sites or locations for an infectious disease healthcare delivery clinic or facility can be evaluated and selected. In other embodiments, at least one infectious disease healthcare delivery clinic or facility can be designed or otherwise modified for suitable operation. In further embodiments, at least one healthcare delivery clinic or facility for any healthcare need can be designed or otherwise modified for suitable operation. An example of an infectious disease healthcare delivery clinic according to one embodiment of the invention is shown as 400 in FIG. 4.

Typically, one or more potential sites or locations for a clinic or facility are assessed and selected. For example, at least one site can be assessed by visiting the site to evaluate suitability for initial clinic design, prospective personnel in the vicinity, and identifying factors that may be relevant to success of the operating clinic or facility. In this manner, various locations for the clinic or facility can be evaluated and prioritized.

In addition, a market study, for example, can be undertaken to determine relevant aspects of a particular location or region. These aspects can include, but are not limited to, existence of sufficient medical or healthcare talent; medical need (large population with infectious disease burden) (epidemiology); whether current healthcare delivery is inadequate; whether the public to private healthcare ratio is less than 1; franchise acceptability, sustainability, and presence of other franchises or healthcare organizations; present high prices for medical care (ability to evaluate healthcare economy); and favorable interest of payors (governments, insurance, medical savings plans). Furthermore, aspects relevant to site or location selection can include, but are not limited to, political climate; availability of referral hospitals; ability to import supplies; accessibility from the United States; and NGO capacity. In addition, aspects relevant to clinic construction in a particular location can be evaluated including, but not limited to, suitable sites with communications capabilities, electricity, water, and security; geographical access to relatively rich and poor communities; construction subcontractors and suitable materials; and the ability to import construction and/or medical equipment.

Furthermore, in the design stage, a review of relatively successful clinic and franchise examples in other healthcare arenas can be undertaken to determine a set of best practices. This may include site visits and interviews to establish a list of common elements or aspects for the successful delivery of healthcare. Some or all of these aspects can be incorporated into a best practices or “best qualities” list for a new clinic design.

Moreover, a predefined number of ideal or otherwise suitable locations can be identified to build and test an initial set of clinics. One example number of initially identified ideal or suitable locations can be 30.

Block 102 is followed by block 104, in which a demand for healthcare services in the at least one location is estimated. In the embodiment shown in FIG. 1, the design stage continues, and target markets for each clinic site or location can be identified and assessed. For example, three discrete target markets including middle income, low income, and no income patients can be selected for marketing a particular clinic's services to, for instance, delivering infectious disease healthcare. In other embodiments, a demand for healthcare services for a particular healthcare need can be evaluated through one or more suitable market and/or target audience studies. In this manner, some or all of the preferences of a target market for a particular clinic can be collected, evaluated, and incorporated into the clinic design. In one embodiment, using some or all of the preferences of a target market for a particular clinic, a comprehensive marketing plan targeted to the particular market can be developed with some or all of the following aspects:
Marketing goals and objectives (to support the overall company/clinic goals and objectives)
Target audience(s)
Primary, secondary and tertiary messages
Features and benefits of the franchisor and its offerings
Marketing communications tactics, including collateral materials, online presence, advertising, promotion and public relations
Budget
Metrics for success

Any number of local leaders, physicians, or healthcare professionals in the selected locations can be identified and eventually recruited to provide input for the new clinic design. In some instances, these leaders may be groomed or otherwise trained to become a clinic owner/operator, particularly for the first or initial clinics in the selected locations.

In addition, local medical or healthcare professionals can be evaluated to staff one or more initial clinics. Various aspects of can be evaluated including, but not limited to, local medical community (doctors, pharmacist, nurses, physician assistants (PA's)) acceptance and expertise, local advocate commitment to reform or at least willingness to experiment, and their proficiency in English speaking and/or writing skills.

Moreover, a panel of qualified or otherwise suitable medical or healthcare professionals including, but not limited to, physicians, leading or prominent infectious disease, internal medicine, and pediatric physicians with private practice experience, epidemiologists, public health experts, infectious disease experts, and microbiologists can be convened to discuss minimal or suitable requirements for practicing their crafts, and to initiate epidemiologic analysis of, for example, the top 10 locations for new clinic placement, clinic design plan, medical equipment list, and clinical microbiology tests.

In this embodiment, an epidemiologic analysis can be undertaken to provide predictions of the diseases that will constitute an arbitrary target, for example, approximately 85%, for each clinic's workload. The analyses can be determined by evaluation of WHO and local reports of prevalence and incident data of regional infectious disease burdens, and by surveys and discussions with local physicians and pharmacists. Similar preliminary work that includes meetings with local physicians and building contractors can permit continued refinement of both medical need and revenue estimates that can provide a preliminary estimate of build-out and operating budget costs. Additional meetings with individuals having international regulatory experience, practical expertise in healthcare delivery, and expertise in achieving franchise efficiency to refine the clinic design can establish lists of minimum equipment and formulary, and assist in developing preliminary operating procedures.

Block 104 is followed by block 106, in which a revenue from healthcare services in the at least one location is estimated. In the embodiment shown in FIG. 1, the design stage continues, and further analyses of the target markets can generate data relevant to determining expected revenue for a new clinic. In other embodiments, an expected revenue for healthcare services for a particular healthcare need can be evaluated through one or more suitable market and/or target audience studies. For example, target market data can provide data on patient access to healthcare in existing systems, the ability and willingness of patients to travel, and the value that the patients place on various features of healthcare, while simultaneously obtaining information on the local healthcare practices. Other data associated with the target markets can determine the relative importance of pricing and delivery of services to establish an understanding of the level of outside support that might be necessary (and for how long) for each potential new clinic, and what local payments to the clinic can be expected. If needed, particular payment systems for healthcare services can be planned for to support the potential new clinic and its supporting franchise. In addition, target market data can be collected using situational analysis and the SWOT methodology (strengths, weaknesses, opportunities, threats) including, but not limited to, data associated with the target audience; the need for the product/service; and the competitive environment and analysis. These and other aspects can assist in determining patient demand and expected revenue for healthcare provided by a new clinic.

Thus, in this example of the design stage, some or all of the following aspects for new clinic design and placement can be identified or otherwise initiated:
Geographical target locations for clinics
Infectious disease epidemiologic analysis of target locations
Equipment/supply/resources/pharmacy stock/support networks necessary for infectious disease healthcare
Market analysis of local healthcare delivery in predefined, selected location sites
Candidate physicians/pharmacists to manage and operate clinics
Candidate employees to operate clinics
Candidate owners for clinics
A first approximation design of a local or neighborhood infectious disease healthcare delivery clinic
Site plan with preliminary cost estimates
Expected patient demand, and clinic revenue

In this manner, a set of diverse markets for the one or more clinics can be identified and analyzed to maximize understanding of the infectious disease healthcare delivery market place, test the relevance of potential success factors, and strengthen any developing business plans. Other embodiments of the invention can include fewer or greater aspects and/or other activities in a design stage for providing an infectious disease healthcare delivery system.

Block 106 is followed by block 108, in which based at least in part on the estimated demand and estimated revenue, a test healthcare delivery clinic in the one location is constructed and operational procedures for the test healthcare delivery clinic are generated. In the embodiment shown in FIG. 1, block 108 begins the “build and test” stage, in which at least one clinic is built and tested. In this embodiment, based at least in part on the site or location evaluation and the target market data analysis, one or more clinics can be built and field tested to evaluate their operation and utility.

Using feedback from the design stage beginning in block 102, one or more locations or sites can be selected, based at least in part on the availability of funding, to construct a test clinic that incorporates some or all of the features determined to be critical or otherwise relatively important for an infectious disease healthcare delivery clinic. In one example, at least 10 locations or sites can be selected to build clinics based at least in part on the availability of funding.

Block 108 is followed by block 110, in which the test healthcare delivery clinic is refined based at least in part on operating the test healthcare delivery clinic in the one location. In the embodiment shown in FIG. 1, the build and test stage continues, in which once at least one test clinic has been constructed, the clinic can be operated as a stand alone facility for a predefined amount of time, for example, one year, to increase operational experience and to refine clinic specifications and operational procedures for each subsequent clinic. For example, feedback from the design stage such as the integration of communications, evidence-based medicine, collection of clinical data, distance learning, and oversight can be incorporated into a new or test clinic design. In this manner, an estimate of the building and operating cost for each subsequent clinic in a specific region or country can be established.

In addition, marketing and epidemiologic investigation of the locations and sites identified as suitable test locations can be completed and analyzed to provide relatively critical or needed data for determining a three-way or factor equation: the cost, the medical need, and the expected revenue/donor commitments balance. Reasonable estimates of these equation values or factors can permit development of a clinic business plan as well as the selection of appropriate sites or locations in a variety of resource-rich and resource-poor regions to test that business plan.

Thus, in this example of the build and test stage, some or all of the following can be identified or otherwise initiated:
Development of a turn key plan for a new clinic
Determining a predefined number, such as 10, of locations suitable for testing a hypothesis that local physicians or other healthcare professionals operating within a franchise system can provide high quality healthcare that is sustainable in some or all communities of a particular region or location

Other embodiments of the invention can include fewer or greater aspects and/or other activities in a build and test stage for providing an infectious disease healthcare delivery system.

Block 110 is followed by block 112, in which based at least in part on refining and operating the test healthcare delivery clinic, a plurality of healthcare delivery clinics are constructed in a corresponding plurality of locations, wherein each of the healthcare delivery clinics is associated with a not-for-profit franchisor entity. In the embodiment shown in FIG. 1, block 112 begins the “implement” stage, in which at least one clinic is implemented. In other embodiments, one or more clinics can be implemented and associated with a for-profit entity. In any instance, for example, at least one clinic is built, equipped, staffed, and provided supplies and infrastructure in a variety of settings. In this embodiment, clinics can operate for a minimum, predefined amount of time, for example, three years, to help determine when each clinic approaches or attains sustainability in each region or country. The “real world” data collected via operations of one or more clinics during this stage can further assist in refining the new or test clinic design, clinic specifications, and operating procedures.

For example, in the implement stage, the role of a home franchise can be evaluated, including some or all of the following: systems and agreements for providing relatively large scale supply and drug procurement, product shipping, and product storage. This data can be evaluated and implemented, and some or all best practices learned during the “design” and “build and test” stages can be implemented. Thus, in this example of the implement stage, some or all of the following can be identified or otherwise initiated:
One or more operational clinics generating data for assessment and refinement of franchise and clinic associated concepts
A validated or evaluated business plan to support capital investment in one or more clinics

Other embodiments of the invention can include fewer or greater aspects and/or other activities in an implement stage for providing an infectious disease healthcare delivery system.

In this embodiment, a franchise can be formed by integrating one or more clinics together in a franchise-type organization. A franchise can include one or more functional departments or groups including, but not limited to, a clinic management department, a training and certification department, a communications and data management department, a financial services department, and a public relations department, or any other department or group capable of supporting one or more clinics and the franchise.

Other embodiments of the invention can include fewer or greater aspects and/or other activities in an integrate stage for providing an infectious disease healthcare delivery system.

The process 100 ends at block 112. Other embodiments of a process for providing an infectious disease healthcare delivery system or a healthcare delivery system for a particular healthcare need in accordance with the invention can have fewer or greater numbers of stages, including some or all of the stages described above.

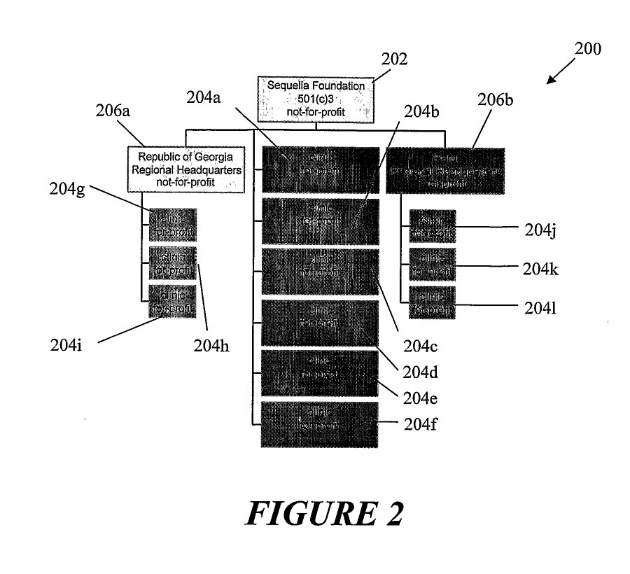

FIG. 2 illustrates an example franchise for an infectious disease healthcare delivery system. In the embodiment shown, a franchise 200 includes at least one franchisor 202, one or more clinics 204, and can include one or more regional centers 206. In other embodiments of the invention, the franchise 200 and franchisor 202 of FIG. 2 may not be limited to delivery of healthcare for infectious diseases, but may also relate to delivery of healthcare for one or more healthcare needs including, but not limited to, family care, birth control, and treatment of a particular infectious disease. One skilled in the art will recognize the applicability of systems and associated processes disclosed herein to the delivery of healthcare and related healthcare services to any healthcare need, including those disclosed above.

The franchisor 202 shown in FIG. 2 acts as a central distribution point for products, processes, and support to one or more clinics 204, and regional units 206 in providing infectious disease healthcare delivery. In the example shown, the franchisor 202 can be a foundation-type organization, a not for profit organization, or an organization complying with 26 U.S.C. (United States Code) Section 501(c)(3). An example of an organization that can act as a franchisor is the Sequella Foundation of Rockdale, Md., United States. Other types of entities can be included or otherwise organized within a franchise, and other types of organizational entities can be used to form a franchise. In other embodiments, a franchisor can be a for-profit entity. Organized in relatively lower tiers from the franchisor 202 are one or more clinics 204a-1.

A clinic can be an entity organized to provide infectious disease healthcare. In other embodiments, a clinic can be an entity organized to provide healthcare for one or more other healthcare needs. In the example shown in FIG. 2, clinics 204a-f can be in direct communication with the franchisor 202 to receive products, processes, and support; and clinics 204g-1 can have indirect communication with the franchisor 202 through one or more regional centers 206 to receive products, processes, and support. For example, the franchisor 202 can transmit or otherwise transfer over-the-counter drugs, medical supplies, medical procedures, and organizational procedures to a clinic, such as 204a. Likewise, the clinics 204a-1 can transfer products, processes, and support to the franchisor either directly or indirectly, depending on the organizational structure of a particular embodiment of a franchise. For example, franchise fees, operating surpluses, and quarterly reports can be transmitted from a clinic, such as 204a, to the franchisor 202. In any instance, clinics 204a-1 can act as commercial business units, and can be organized as for-profit or not-for-profit entities.

Also organized in relatively lower tiers from the franchisor 202 can be one or more regional units 206a-b. A regional unit can be an entity organized to supervise some or all of the regional activities of clinics located in a particular region, country, state, county, city, or a general vicinity, for instance, the Republic of Georgia, or the nation of Peru. In the example shown in FIG. 2, regional units 206a-b can be in direct communication with the franchisor 202 to receive products, processes, and support, and in further communication with one or more clinics 204a-1 to transfer products, processes, and support received from the franchisor 202. For example, a regional unit such as 206a can transmit or otherwise transfer over-the-counter drugs, medical supplies, medical procedures, and organizational procedures received from the franchisor 202 to a clinic, such as 204a. Likewise, regional units 206a-b can transfer products, processes, and support from the clinics 204a-1 to the franchisor 202 as needed. For example, franchise fees, operating surpluses, and quarterly reports can be transmitted from a regional unit, such as 206a, to the franchisor 202. Respectively, clinics 202g-i can in communication with regional unit 206a to receive some or all of their products, processes, and support from the regional unit 206a; and likewise, clinics 202j-1 can in communication with regional unit 206b to receive some or all of their products, processes, and support from the regional unit 206b. In any instance, regional units 206a-b can act as commercial business units, and can be organized as for-profit or not-for-profit entities.

The number of franchisors, clinics, and regional centers shown in FIG. 2 is by way of example, and the organizational alignment of the franchisors, clinics, and regional centers with respect to each other is also shown by way of example. Other embodiments of the invention can have fewer or greater numbers of franchisors, clinics, and regional centers, and may have different organizational alignments than shown.

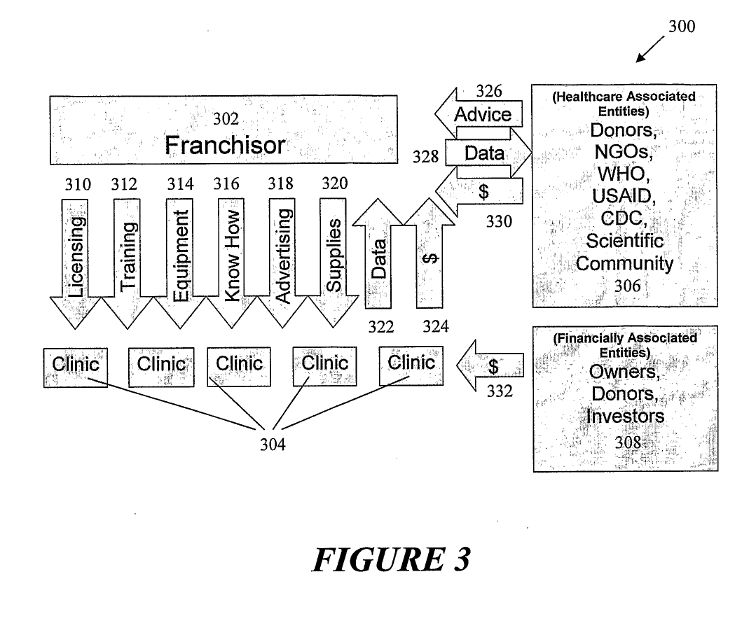

FIG. 3 illustrates a process 300 and flow of information and other products and/or monies between entities in accordance with an embodiment of the invention. In the example shown in FIG. 3, a franchisor 302 interacts with one or more clinics 304, one or more healthcare associated entities 306, and one or more financially associated entities 308.

The franchisor 302 shown in FIG. 3 is similar to the franchisor shown in FIG. 2 as 202. Similarly, the clinics 304 shown in FIG. 3 are similar to the clinics shown in FIG. 2 as 204a-1. Even though some types of clinics 204f-1 shown in FIG. 2 interact with a respective regional unit 206a-b and corresponding regional units are not shown in FIG. 3, the positioning of clinics and regional units in FIG. 3 would be similar, and therefore interchangeable.

The healthcare associated entities 306 shown in FIG. 3 can include, but are not limited to, donors, non-governmental organizations (NGOs), the World Health Organization (WHO), the United States Agency for International Development (USAID), the Centers for Disease Control (CDC), members of the scientific community, and other entities or persons interested in or otherwise associated with healthcare.

The financially associated entities 308 shown in FIG. 3 can include, but are not limited to, franchise owners, donors, franchisor investors, clinic investors, regional unit investors, and other entities or persons interested or otherwise financially associated with a franchisor, clinic, regional unit, or franchise.

As shown in the embodiment of FIG. 3, various information and products can be transmitted or otherwise transferred from the franchisor 302 to one or more of the clinics 304. In this example, the information and products can include, but are not limited to, licensing information 310, training 312, equipment 314, know how 316, advertising 318, and supplies 320. Furthermore, various information and products can be transmitted or otherwise transferred from one or more of the clinics 304 to the franchisor 302. In this example, the information and products can include, but are not limited to, data 322 and monies 324. Other types of information and products can be exchanged between the franchisor 302 and the one or more of the clinics 304, and the above examples are not intended to be limiting.

In addition, various information and products can be transmitted or otherwise transferred from the franchisor 302 to one or more of the healthcare associated entities 306. In this example, the information and products can include, but are not limited to, data 326. Furthermore, various information and products can be transmitted or otherwise transferred from one or more of the healthcare associated entities 306 to the franchisor 302. In this example, the information and products can include, but are not limited to, advice 328 and monies 330. Other types of information and products can be exchanged between the franchisor 302 and the one or more of the healthcare associated entities 306, and the above examples are not intended to be limiting.

Referring to the financially associated entities 308, various information and products can be transmitted or otherwise transferred from one or more of the financially associated entities 308 to one or more of the clinics 304. In this example, the information and products can include, but is not limited to, monies 332. Optionally, various information and products can be transmitted or otherwise transferred from one or more of the clinics 304 to one or more of the healthcare associated entities. For example, the information and products can include, but are not limited to, operational or financial-type data. Other types of information and products can be exchanged between the one or more of the financially associated entities 308 and the one or more of the clinics 304, and the above examples are not intended to be limiting.

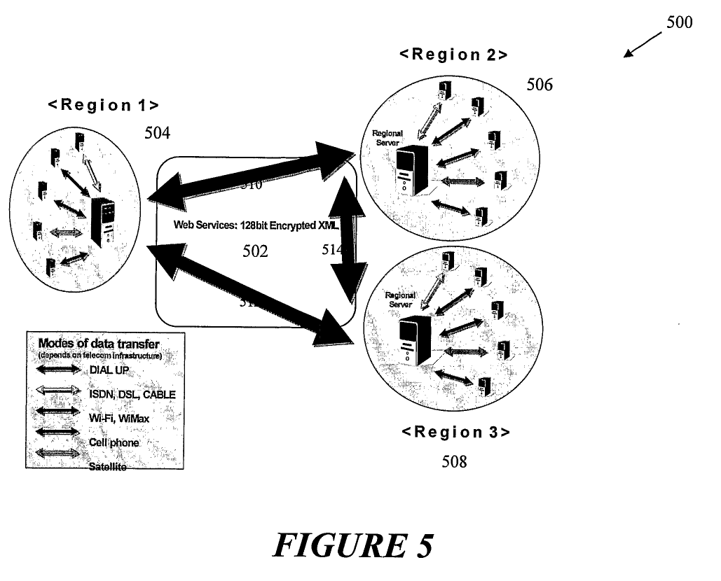

In the embodiment shown in FIG. 3, the franchisor 302 can communicate with the clinics 304, and healthcare associated entities 306 through an electronic network shown as 500 in FIG. 5 and further described below. As shown in FIG. 5, the electronic network includes communication links 510, 512, 514 between entities or between at least one entity in two particular regions, such as franchisor in the United States and a regional unit in the Republic of Georgia or a clinic in Peru. Such communication links can be used to transmit or otherwise facilitate transfer of some or all of the information and products between entities, including 310, 312, 314, 316, 318, 320, 322, 324, 326, 328, 330, and 332 of FIG. 3. Communication links 510, 512, 514 can be wired and/or wireless communication devices and methods used to facilitate the exchange of signals, information, products, supplies, invoices, monetary funds, and payments, as needed. In one embodiment, a communication link can be facilitated by a postal mail delivery service. In other embodiments, some or all communications links 510, 512, 514 can be facilitated by any combination of communication means such as wired and/or wireless communications devices and methods, and postal mail delivery service.

In any instance, the franchisor 302 can exchange information and products, including monies, with several entities including clinics 304 and healthcare associated entities 306, and the clinics 304 can exchange information and products, including monies, with several entities including the franchisor and financially associated entities 308.

The process 300 illustrated in FIG. 3 is shown by arrows 310, 312, 314, 316, 318, 320, 322, 324, 326, 328, 330, and 332. Each arrow represents a flow of information, products and/or monetary funds between the various entities associated with an infectious disease healthcare delivery system.

The exchange of information, products and/or monetary funds performed in the process 300 above can be fewer or greater than the elements described above in accordance with other embodiments of the invention. Furthermore, the order of the steps performed in the process 300 above can be arranged in any order in accordance with other embodiments of the invention. Moreover, other processes to provide an infectious disease healthcare delivery system can be accomplished with fewer or greater numbers of information, payments, products, entities, franchisors, clinics and/or parties in accordance with other embodiments of the invention.

FIG. 4 illustrates an example infectious disease healthcare delivery clinic 400 or facility. In the embodiment shown, a clinic such as 400 can be a self-contained, stand alone provider of infectious disease vaccination, diagnosis, treatment and preventative therapy. The clinic 400 shown can include a standardized floor plan with one or more functional areas, such as, but not limited to, an admissions room 402, a training area, a waiting room, an administration area, a pharmacy 404, a laboratory 406, a bathroom 408, and a patient examination area 410. The embodiment of the clinic 400 shown also includes a communication link 412 capable of exchanging information with a franchisor entity, such as 202 in FIG. 2 or 302 in FIG. 3. In this example, the communication link can provide continuous voice and data communication with a franchisor, such as 202, or a franchise headquarters or regional franchise locations such as a regional unit 206a in FIG. 2.

In some embodiments, a physical plant can be implemented in a clinic such as 400 to readily provide clean air and potable water in an environment suitable for providing healthcare. Other embodiments of a clinic such as 400 can provide for security and electrical outages, and suitable physical and backup systems can be incorporated into the clinic design. In yet other embodiments, a clinic such as 400 can include additional space for medical and office equipment, inventory, formulary, a communications system for transmission of data and information, and a development department for education and continuing education programs.

Other embodiments of a clinic can have fewer or greater numbers of functional areas than those described above in accordance with the invention.

In the embodiment shown, modular equipment that has been tested and determined to be suitable for infectious disease diagnosis and treatment can be implemented within the clinic 400.

Equipment can be maintained by trained personnel, who may be full-time at the particular clinic or may be employed by the franchise system to handle maintenance at multiple local clinics. In other embodiments, other modular-type equipment suitable for use with providing treatment for other healthcare needs can be implemented within a clinic.

Furthermore, in this embodiment, optimal clinical testing methods for diseases anticipated by the clinic location can be implemented, and the most efficient use of space and resources for a laboratory that can be easily administered by a technician and readily monitored by the franchise can also be implemented. Significant efficiencies are anticipated by coordinating the testing procedures and consolidating equipment. In other embodiments, other clinic testing methods suitable for use with providing treatment for other healthcare needs can be implemented within a clinic.

In addition, the clinic 400 can have a standardized quality assurance and management program. Some or all healthcare services and inventory can be carefully monitored inventory to achieve suitable performance and efficiency goals. For example, therapeutics can be delivered by a national carrier (UPS, FedEx, or equivalent) directly to the clinic. Procedures can be developed to track, document and ensure the integrity of therapeutics administered by the clinic. By way of another example, each clinic can provide a transparent mechanism for evaluating clinic performance, which can translate into evidence-based medicine. The franchise and the physicians can evaluate prescribing patterns and clinical success to optimize individual and organizational efficacy.

In the embodiment shown, the clinic 400 can be occupied by a standardized staff including, but not limited to, several physicians, physician's assistants (PS), or nurse practitioners, a pharmacist or pharmacy technician, a laboratory technician, and a nurse/receptionist/data entry person. Additional nursing, administrative and cleaning personnel functions can be added as subsequent time and motion studies demonstrate their effectiveness. In one embodiment, there may be up to two operating shifts per day to maximize the use of the clinic, with only the number of staff present at the clinic to accomplish the needed tasks. An example clinic is expected to have a patient capacity of approximately 150 patients per 16 hour period.

In other embodiments, a suitable size and configuration can be determined by architects, and a readily identifiable, unique architectural style can be determined to identify a source of healthcare services. In one embodiment of a clinic, such as 400, a floor plan can have a size of approximately 1500 square feet with storage and utility space on an upper level.

The functional areas 402, 404, 406, 408, and 410 shown in FIG. 4 can have dual or multiple uses to maximize the space usage within the clinic 400. For example, a reception area can be designed to be used as a reception area during operating hours and as a training/professional development area for any other time. Even though the floor plan shown in FIG. 4 may lack any number of amenities usually deemed essential in other countries, other functional areas shown in FIG. 4 can be utilized or facilitate needed capabilities. For instance, some or medical records can be stored on a local or remote computer in communication with communication link 412. Depending on the cost and need, other functional areas or space may be added to the floor plan or clinic 400.

In the embodiment shown in FIG. 4, the clinic 400 is suitable for implementing clinic workflow techniques. For example, patients entering the clinic can be evaluated by a nurse practitioner working at a computer terminal. New patients can be issued an identifier card which can connect their patient identifier information with their clinical date to ensure privacy but allow the franchise system access to the clinical data. The nurse can enter a health history, patient-reported symptoms and blood pressure, pulse and oral temperature. The computer can use an algorithm to ask the nurse to query for additional patient symptoms or information. The computer can suggest the laboratory tests that should be performed at this time. The nurse practitioner can add tests or override the system to remove tests. The computer can provide labels and guidance for collection of specimens and alert the lab that testing has been requested. This example of workflow management represents one current best practice in managing patients, tracking patient data, and outlining possible treatment based on clinical strategies with proven success. The WHO integrated management of childhood illness (IMCI) is an example of such a system that can implement a workflow management process.

In some cases the history and/or test results can provide sufficient information to establish that the patient does not have an infectious disease and may need either counseling or referral, or the results may clearly demonstrate what therapy is appropriate and the patient can be referred directly to the pharmacist.

If necessary, a physician can see the patient in the appropriately designed examination rooms. The physician's computer monitor may have some or all the patient information, a suggested differential from the history, symptoms and laboratory results, and can provide suggestions for refining the differential. The physician can enter data as he or she conducts his physical exam and patient interrogation. For each diagnosis, the computer can suggest therapies in the formulary, possible drug interactions, and literature references for the doctor. The physician can override the system to make a diagnosis or prescribe therapy, he or she can make comments for himself or herself, and suggestions which are directed to the franchise computer system for evaluation by the franchise.

Using some or all of the above aspects or the above embodiments, a franchise clinic can be affordable to potential owner-investors with a relatively low break even (i.e. economically self sustaining) point. The clinic 400 shown in FIG. 4 can, in some instances, support economic viability and superior medical outcomes including, but not limited to, providing relatively lower capital requirement, and providing continual process improvement, training, and sharing of best practices throughout the franchise system; and providing focus on prevalent diseases and treatments so that clinics can diagnose and treat approximately 85% of infectious disease cases that visit the clinic rather than trying to cover all situations, which could require enormous additional investment in space, equipment, supplies, and training. In other embodiments, a franchise clinic can provide healthcare for addressing other healthcare needs and still be affordable to potential owner-investors with a relatively low break even point.

FIG. 5 illustrates an example network for a franchise system in accordance with an embodiment of the invention. The electronic network shown as 500 in FIG. 5 can facilitate communications between various entities in a franchise system such as 200 in FIG. 2 using the Internet 502 or similar network. For example, the Internet 502 or similar type network can facilitate communications between an entity such as a franchisor similar to 202 in region 504 and another entity such as a clinic similar to 204a in region 506. Likewise, the Internet 502 or similar type network can facilitate communications between an entity such as a clinic similar to 204a in region 506 and another entity such as a regional unit similar to 206a in region 508. As shown in FIG. 5, the electronic network 500 includes communication links 510, 512, 514 between entities or between at least one entity in particular regions, such as 504, 506, 508. Such communication links can be used to transmit or otherwise facilitate transfer of some or all of the information and products between entities, including a franchisor, clinics, and regional units, such as information and products illustrated as 310, 312, 314, 316, 318, 320, 322, 324, 326, 328, 330, and 332 of FIG. 3. As explained above, communication links 510, 512, 514 can be wired and/or wireless communication devices and methods used to facilitate the exchange of signals, information, products, supplies, invoices, monetary funds, and payments, as needed. In one embodiment, a communication link can be facilitated by a postal mail delivery service. In other embodiments, some or all communications links 510, 512, 514 can be facilitated by any combination of communication means such as wired and/or wireless communications devices and methods, and postal mail delivery service. Any type of communication mode can be facilitated between entities in the network 500 shown including, but not limited to, dial up, ISDN, DSL, cable, WIMAX, WIFI, cellular, or satellite.

In the embodiment shown in FIG. 5, the network 500 can implement and facilitate computerized information and process flows for a clinic, such as 400 in FIG. 4, and a franchise system, such as 200 in FIG. 2. For example, various information and process flows can include, but are not limited to, data at admission (patient history, including symptoms), local infectious disease patterns, physician observation and diagnosis, and lab results entered into the computer can be used to develop and refine a diagnostic algorithm to facilitate proper diagnosis, improve efficiency and allow the franchise system to effectively monitor disease epidemiology or healthcare needs locally, nationally, and even internationally. In addition, some or all of the following functionality can be implemented or otherwise facilitated with the network 500 shown in FIG. 5: Clinics such as 204a in FIG. 2 can use a video communications screen in the reception/training area, such as 402 in FIG. 4, for patient entertainment-education during clinic hours and for staff development/training broadcast after-hours or downloadable on demand; staff can have access to a franchise-operated website and/or database that will provide them with regularly updated information on infectious diseases or other healthcare services or needs, educational modules for professional development, as well as any specific local information gathered from other local franchises that can help them to improve the quality of the healthcare they provide; during operating hours, patients can have access to another branch of this franchise-operated website and/or database that can provide them with layperson-directed information on diseases and/or healthcare needs or services.

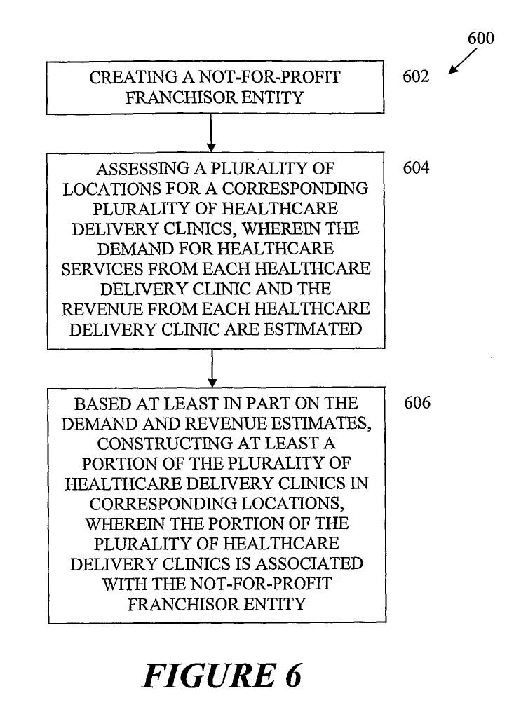

Another example method that can be performed by embodiments of the invention is illustrated in FIG. 6. The method shown in FIG. 6 can be implemented in conjunction with the example franchise system 200 shown in FIG. 2. In particular, the process 600 shown in FIG. 6 illustrates particular elements for designing, developing, and refining an infectious disease healthcare delivery system in accordance with an embodiment of the invention. This and other methods can be performed or otherwise implemented on other system embodiments in accordance with other embodiments of the invention. In other embodiments of the invention, the process of FIG. 6 may not be limited to delivery of healthcare for infectious diseases, but may also relate to delivery of healthcare for one or more healthcare needs including, but not limited to, family care, birth control, and treatment of a particular infectious disease.

The method 600 of FIG. 6 begins at block 602. In block 602, a not-for-profit franchisor entity is created. In the embodiment of FIG. 6, a not-for-profit franchisor entity can be a foundation-type organization, a not for profit organization, or an organization complying with 26 U.S.C. (United States Code) Section 501(c)(3). An example of an organization that can act as a not-for-profit franchisor entity is the Sequella Foundation of Rockdale, Md., United States. In other embodiments, a franchisor entity can be a for-profit entity.

Block 602 is followed by block 604, in which a plurality of locations for a corresponding plurality of healthcare delivery clinics are assessed, wherein the demand for healthcare services from each healthcare delivery clinic and the revenue from each healthcare delivery clinic are estimated. In the embodiment of FIG. 6, an assessment of one or more sites or locations for healthcare delivery clinics can be performed. In addition to evaluating the sites or locations, a market analysis of the demand for healthcare services from each healthcare delivery clinic in each location, and the revenue from each healthcare delivery clinic in each location can be performed.

Block 604 is followed by block 606, in which based at least in part on the demand and revenue estimates, at least a portion of the plurality of healthcare delivery clinics are constructed in corresponding locations, wherein the portion of the plurality of healthcare delivery clinics is associated with the not-for-profit franchisor entity. In the embodiment of FIG. 6, the results of the site assessment and the demand estimates described at block 604 can be utilized to construct at least one healthcare delivery clinic. Each of the healthcare delivery clinics is associated with the not-for-profit franchisor entity through, for example, a franchisor-franchisee agreement or relationship. In other embodiments, one or more healthcare delivery clinics can be associated with a for-profit franchisor entity.

At block 606, the method 600 ends. Other embodiments of a process for providing an infectious disease healthcare delivery system or other delivery system for healthcare needs in accordance with the invention can have fewer or greater numbers of elements, including some or all of the elements described above.

While the above description contains many specifics, these specifics should not be construed as limitations on the scope of the invention, but merely as exemplifications of the disclosed embodiments. Those skilled in the art will envision any other possible variations that are within the scope of the invention.

1. A method for providing a healthcare delivery franchise system, comprising:
creating a not-for-profit franchisor entity;
assessing a plurality of locations for a corresponding plurality of healthcare delivery clinics, wherein the demand for healthcare services from each healthcare delivery clinic and the revenue from each healthcare delivery clinic are estimated; and
based at least in part on the demand and revenue estimates, constructing at least a portion of the plurality of healthcare delivery clinics in corresponding locations, wherein the portion of the plurality of healthcare delivery clinics is associated with the not-for-profit franchisor entity.

2. The method of claim 1, further comprising:
assessing a demand for treatment of at least one infectious disease in each location, wherein constructing at least a portion of the plurality of healthcare delivery clinics is further based on the demand for treatment of the at least one infectious disease in each location.

3. The method of claim 2, wherein each healthcare delivery clinic is capable of providing healthcare to patients with the at least one infectious disease.

4. The method of claim 1, wherein the not-for-profit franchisor entity is a foundation-type organization.

5. The method of claim 1, wherein each healthcare delivery clinic is a stand alone facility in communication with the not-for-profit franchisor entity.

6. The method of claim 1, wherein the not-for-profit franchisor entity is capable of providing each healthcare delivery clinic with at least one of the following: a medical product, a drug, a vaccine, instructions for performing a medical procedure, operational instructions, or medical supplies.

7. The method of claim 1, wherein at least one healthcare delivery clinic provides the not-for-profit franchisor with at least one of the following: a franchise fee, surplus operating funds, or a report associated with the quantity of healthcare services provided to patients.

8. A method for providing a healthcare delivery franchise system, comprising:
evaluating at least one location for a healthcare delivery clinic;
estimating a demand for healthcare services in the at least one location;
estimating a revenue from healthcare services in the at least one location;
based at least in part on the estimated demand and estimated revenue, constructing a test healthcare delivery clinic in the one location and generating operational procedures for the test healthcare delivery clinic;
refining the test healthcare delivery clinic based at least in part on operating the test healthcare delivery clinic in the one location; and
based at least in part on refining and operating the test healthcare delivery clinic, constructing a plurality of healthcare delivery clinics in a corresponding plurality of locations, wherein each of the healthcare delivery clinics is associated with a not-for-profit franchisor entity.

9. The method of claim 8, wherein the demand is based in part on at least one of the following: a market analysis of potential patients, or an epidemiological analysis of at least one infectious disease in the one location.

10. The method of claim 9, wherein each healthcare delivery clinic is capable of providing healthcare to patients with at least one infectious disease.

11. The method of claim 9, wherein the not-for-profit franchisor entity is a foundation-type organization.

12. The method of claim 9, wherein each healthcare delivery clinic is a stand alone facility in communication with the not-for-profit franchisor entity.

13. The method of claim 9, wherein the not-for-profit franchisor entity is capable of providing each healthcare delivery clinic with at least one of the following: a medical product, a drug, a vaccine, instructions for performing a medical procedure, operational instructions, or medical supplies.

14. The method of claim 9, wherein at least one healthcare delivery clinic provides the not-for-profit franchisor with at least one of the following: a franchise fee, surplus operating funds, or a report associated with the quantity of healthcare services provided to patients.

15. A healthcare delivery clinic with a physical location, comprising:
an association with a not-for-profit franchisor entity;
a standardized floor plan with at least one functional area, wherein the floor plan is common to at least one other healthcare delivery clinic associated with the not-for-profit franchisor entity; and
a communication link for sharing information with the not-for-profit franchisor entity.

16. The healthcare delivery clinic of claim 15, wherein the physical location of the clinic is determined at least in part on an assessment of a demand for treatment of at least one infectious disease in a vicinity of the physical location, and further determined at least in part on an assessment of demand for treatment of the one infectious disease in the vicinity of the physical location.

17. The healthcare delivery clinic of claim 15, wherein the clinic is capable of providing healthcare to patients with at least one infectious disease.

18. The healthcare delivery clinic of claim 15, wherein the not-for-profit franchisor entity is a foundation-type organization.

19. The healthcare delivery clinic of claim 15, wherein the healthcare delivery clinic is a stand alone facility in communication with the not-for-profit franchisor entity.

20. The healthcare delivery clinic of claim 15, wherein the not-for-profit franchisor entity is capable of providing the healthcare delivery clinic with at least one of the following: a medical product, a drug, a vaccine, instructions for performing a medical procedure, operational instructions, or medical supplies.

21. The healthcare delivery clinic of claim 15, wherein the healthcare delivery clinic provides the not-for-profit franchisor with at least one of the following: a franchise fee, surplus operating funds, or a report associated with the quantity of healthcare services provided to patients.
